(19) United States
(12) Patent Application Publication
(10) Pub. No.: US 2022/0004798 A1
(43) Pub. Date: Jan. 6, 2022

(54) Systems and Methods of Nonlinear Image Intensity Transformation for Denoising and Low-Precision Image Processing

(71) Applicant: BlinkAI Technologies, Inc., Boston, MA (US)

(72) Inventors: Bo Zhu, Charlestown, MA (US); Haitao Yang, Boston, MA (US); Liying Shen, Charlestown, MA (US)

(73) Assignee: BlinkAI Technologies, Inc., Boston, MA (US)

(21) Appl. No.: 17/367,216

(22) Filed: Jul. 2, 2021

Related U.S. Application Data
(60) Provisional application No. 63/047,875, filed on Jul. 2, 2020.

(51) Int. Cl. G06K 9/46; G06T 5/00; G06T 5/50; G06N 3/08

(52) U.S. Cl. CPC G06K 9/4633; G06T 5/002; G06T 2207/20081; G06N 3/08; G06T 2207/20084; G06T 5/50

(57) ABSTRACT

The techniques described herein provide for transforming images and/or quantizing images using nonlinear techniques. The transformed images can be used for image enhancement (e.g., transformation and/or quantization may be a pre-processing step prior to performing image enhancement). For example, the nonlinear intensity transformation techniques can provide for efficient denoising, better low-precision image processing, and/or the like, compared to performing image processing on the original image.

### RELATED APPLICATIONS

The present application claims priority to U.S. Provisional Patent Application Ser. No. 63/047,875 entitled “Systems and Methods of Nonlinear Image Intensity Transformation for Denoising and Low-Precision Image Processing,” to Zhu et al., filed Jul. 2, 2020, the disclosure of which is hereby incorporated by reference in its entirety.

### FIELD OF THE DISCLOSURE

The techniques described herein relate generally to techniques of processing an image to be enhanced, and more specifically to modifying pixel values using a nonlinear transformation.

### BACKGROUND

An image may be captured by an image capture device (e.g., an image sensor of a digital camera). The captured image may be of poor quality due to conditions in which the image was captured. For example, the image may have noise due to insufficient lighting, short exposure time, and/or other conditions. Furthermore, the captured image may be of poor quality due to limitations of the image capture device. For example, the image capture device may not have a mechanism for compensating for the conditions in which the image was captured.

### SUMMARY

The techniques described herein provide for transforming image intensity values of an image (e.g., pixel values) using nonlinear techniques. The transformed images can be used for image enhancement (e.g., as a preprocessing step prior to performing image enhancement). For example, the nonlinear intensity transformation techniques can provide for efficient denoising, better low-precision image processing, and/or the like, compared to performing image processing on the original image.

According to one aspect, a computer-implemented method of processing an image. The method comprises: using at least one processor to perform: obtaining an input image comprising pixels of a first bit depth; quantizing the input image at least in part by applying a first nonlinear transform to pixel intensities of the input image to generate a quantized input image comprising pixels of a second bit depth, wherein the second bit depth is less than the first bit depth; and providing the quantized input image for image processing.

In one embodiment, quantizing the input image comprises: obtaining a transformed input image from applying the first nonlinear transform to the pixel intensities of the input image; and applying a surjective mapping to pixel intensities of the transformed input image to obtain the quantized input image, wherein the surjective mapping maps pixel intensities of the first bit depth to pixel intensities of the second bit depth.

In one embodiment, the second bit depth comprises a first pixel intensity and a second pixel intensity, wherein the first pixel intensity is less than the second pixel intensity; and quantizing the input image comprises mapping a fewer number of pixel intensities of the first bit depth to the first pixel intensity than to the second pixel intensity.

In one embodiment, the method further comprises: obtaining, from the image processing pipeline, an output image comprising pixels of the second bit depth; and de-quantizing the output image at least in part by applying a second nonlinear transform to pixel intensities of the output image to generate a de-quantized output image comprising pixels of the first bit depth. In one embodiment, the second nonlinear transform comprises an inverse of the first nonlinear transform.

In one embodiment, providing the quantized input image to the image processing pipeline comprises providing the quantized input image to a neural processor. In one embodiment, providing the quantized input image to the image processing pipeline comprises providing the quantized input image to a digital signal processor (DSP). In one embodiment, the image processing pipeline comprises one or more processors that are of lower power than the at least one processor.

In one embodiment, the first bit depth is 10 bits, 12 bits, 14 bits, or 16 bits. In one embodiment, the second bit depth is 8 bits. In one embodiment, the first bit depth is 10 bits, 12 bits, 14 bits, or 16 bits; and the second bit depth is 8 bits.

In one embodiment, the image processing pipeline comprises a machine learning model trained using a plurality of quantized images comprising pixels of the second bit depth; and providing the quantized input image to the image processing pipeline comprises providing the quantized input image to the machine learning model to obtain an enhanced output image.

According to another aspect, a computer-implemented method of training a machine learning model for image enhancement is provided. The method comprises: using at least one processor to perform: obtaining a plurality of images comprising pixels of a first bit depth; quantizing the plurality of images at least in part by applying a nonlinear transform to pixel intensities of the plurality of images to generate a plurality of quantized images comprising pixels of a second bit depth, wherein the second bit depth is less than the first bit depth; and training the machine learning model using the plurality of quantized images.

According to one embodiment, the plurality of images comprises input images and target output images and training the machine learning model using the plurality of quantized images comprises applying a supervised learning algorithm to quantized input images and quantized target output images.

According to one embodiment, the machine learning model comprises a neural network. According to one embodiment, training the machine learning model using the plurality of quantized images comprises training the machine learning model to denoise an input image.

According to another aspect, a computer-implemented method of enhancing an image is provided. The method comprises: using at least one processor to perform: obtaining an input image to be enhanced; applying a nonlinear transform to pixel intensities of the input image to obtain a transformed input image; generating, using the transformed input image, an input be provided to a trained machine learning model; and providing the generated input to the trained machine learning model to obtain an enhanced output image.

In one embodiment, the input image has a first variance of a noise property across the pixel intensities of the input image; the transformed input image has a second variance of the noise property across the pixel intensities of the input image; and the second variance is less than the first variance. In one embodiment, the noise property is noise standard deviation.

In one embodiment, the trained machine learning model is trained to denoise the input. In one embodiment, the trained machine learning model comprises a neural network. In one embodiment, the trained machine learning model is generated by applying a supervised training algorithm to training data.

In one embodiment, the input image comprises pixels of a first bit depth;

generating the input using the transformed input image comprises: quantizing the transformed input image to obtain a quantized input image comprising pixels of a second bit depth, wherein the second bit depth is less than the first bit depth; and providing the generated input to the trained machine learning model comprises providing the quantized input image as the input to the trained machine learning model. In one embodiment, quantizing the transformed input image comprises applying a surjective mapping to pixel intensities of the transformed input image, wherein the surjective mapping maps the pixel intensities of the first bit depth to pixel intensities of the second bit depth.

In one embodiment, the second bit depth comprises a first pixel intensity and a second pixel intensity, wherein the first pixel intensity is less than the second pixel intensity; and

quantizing the input image comprises mapping a fewer number of pixel intensities of the first bit depth to the first pixel intensity than to the second pixel intensity.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 shows a block diagram of an illustrative system in which techniques described herein may be implemented, according to some embodiments of the invention described herein.

FIG. 2 shows a flow chart of an example process for processing an image, according to some embodiments of the invention described herein.

FIG. 3 shows a flow chart of an example process for quantizing an image, according to some embodiments of the invention described herein.

FIG. 4 shows a flow chart of an example process for de-quantizing an image, according to some embodiments of the invention described herein.

FIG. 5 shows a flow chart of an example process for enhancing an image, according to some embodiments of the invention described herein.

FIG. 6 shows a block diagram of an illustrative system for training a machine learning model, according to some embodiments of the invention described herein.

FIG. 7 shows a flow chart of an example process for training a machine learning model for image enhancement, according to some embodiments of the invention described herein.

FIG. 8 shows plots illustrating linear quantization of pixel intensities, according to some embodiments.

FIG. 9 shows plots illustrating nonlinear quantization of pixel intensities using a logarithmic function, according to some embodiments.

FIG. 10 shows plots illustrating nonlinear quantization of pixel intensities using an exponential function, according to some embodiments.

FIG. 11 shows plots illustrating reduction of noise property variance from application of a nonlinear transform, according to some embodiments.

FIG. 12 shows a block diagram of an illustrative computing device that may be used to implement some embodiments of the invention described herein.

### DETAILED DESCRIPTION

Turning now to the drawings, systems and methods for nonlinear image intensity transformation for denoising and image processing in accordance with embodiments of the invention are described. An image captured by an image capture device (e.g., using an image sensor) may be represented by a higher dynamic range than a computing device (e.g., a processor) is equipped to handle. For example, an image captured using a CMOS image sensor may have pixels of 14-bit depth, while a low power digital signal processor (DSP), neural processing unit (NPU), and/or the like, may be limited to processing images with pixels of 8-bit depth. The DSP, NPU, and/or the like may be limited to 8-bit inputs and/or may be configured to perform 8-bit operations. Conventional systems may apply linear quantization to an image to reduce the bit depth of the image for processing by the computing device. However, such quantization of the image can often lead to information loss and thus lower image quality of the processed image.

Many embodiments of the invention recognize that there can be a nonlinear relationship between luminance and human visual perception. For example, humans viewing a digital image are typically more sensitive to absolute intensity changes of pixels or areas of pixels at low luminance (e.g., low pixel intensities) than to changes at high luminance (e.g., high pixel intensities). Accordingly, described herein are techniques of nonlinear image intensity transformation and/or quantization that can mitigate the loss of perceived image quality resulting from image processing operating on quantized image data. Techniques described herein exploit the nonlinear relationship between luminance and human visual perception to obtain transformed images with lower loss in image quality. Some embodiments apply nonlinear intensity transformations to an image and quantize the image to reduce bit depth of the image while minimizing discrimination among low pixel intensities.

Noise properties may vary with pixel intensities in an image. For example, the standard deviation of noise may vary with pixel intensity. Certain embodiments of the invention recognize that complexity of a machine learning model trained for image enhancement (e.g., denoising) increases when images that are to be enhanced have a high variance in noise properties (e.g., standard deviation) across pixel intensities. For example, a neural network model being trained to enhance images (e.g., by denoising the images) may require more layers, channels, and thus weights when input images have high variance in noise standard deviation across pixel intensities because the model needs to account for multiple noise levels. As the complexity of the machine learning model increases, the efficiency of a computing device employing the machine learning model decreases because the computing device may require more computations, memory, and power to enhance (e.g., denoise) the image. For example, a neural processor enhancing an image by executing a neural network trained for denoising becomes less efficient as the number of layers of the neural network increase because the computing device requires more computation, memory, and power per image pixel to denoise the image.

Accordingly, some techniques described herein apply a nonlinear transform to pixel intensities of an image to reduce noise property variation in the image across pixel intensities. The lower noise property variation across pixel intensities can reduce the complexity of the machine learning model needed to enhance the image, as the model is required to denoise a smaller range of noise levels. Thus, a computing device that uses the machine learning model may process the image more efficiently. Some embodiments apply a nonlinear transform to pixel intensities of an image in conjunction with quantization or requantization of the image. Some embodiments apply a nonlinear transform to pixel intensities of an image without quantizing the image.

In additional embodiments of the invention, an image or images prepared by techniques such as those described here can be used as training data for a machine learning model or can be provided to a trained machine learning model as input data to be enhanced. Systems and methods for enhancing images and training machine learning models are disclosed in US. Pat. Pub. No. 2020/0051217 (application Ser. No. 16/634,424) to Shen et al. (the '217 Publication), the relevant portions of which are hereby incorporated by reference in their entirety and a copy of which is enclosed as Appendix A.

In the following description, numerous specific details are set forth regarding the systems and methods of the disclosed subject matter and the environment in which such systems and methods may operate, etc., in order to provide a thorough understanding of the disclosed subject matter. Some embodiments described herein address the above-described issues with conventional image processing techniques. However, it should be appreciated that not every embodiment described herein addresses every one of these issues. It should also be appreciated that embodiments of the invention described herein may be used for purposes other than addressing the above-discussed issues of conventional image processing techniques. In addition, it will be understood that the examples provided below are exemplary, and that it is contemplated that there are other systems and methods that are within the scope of the disclosed subject matter.

### Image Processing Systems

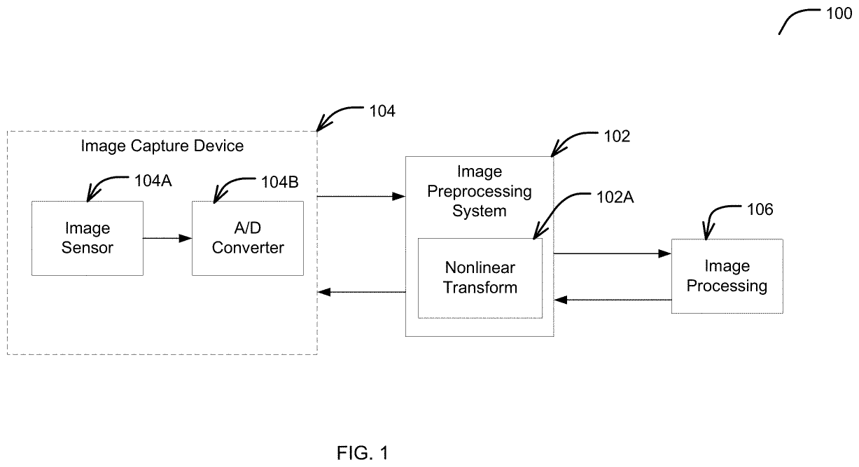

FIG. 1 shows a block diagram of a system 100 in which techniques described herein may be implemented, according to some embodiments. As shown in FIG. 1, the system 100 includes an image preprocessing system 102 (also referred to herein as “system 102”), an image capture device 104, and an image processing system 106. In some embodiments, image preprocessing system 102 may be a component of image enhancement system 111 of FIGS. 1A-B of the '217 Publication (Appendix A).

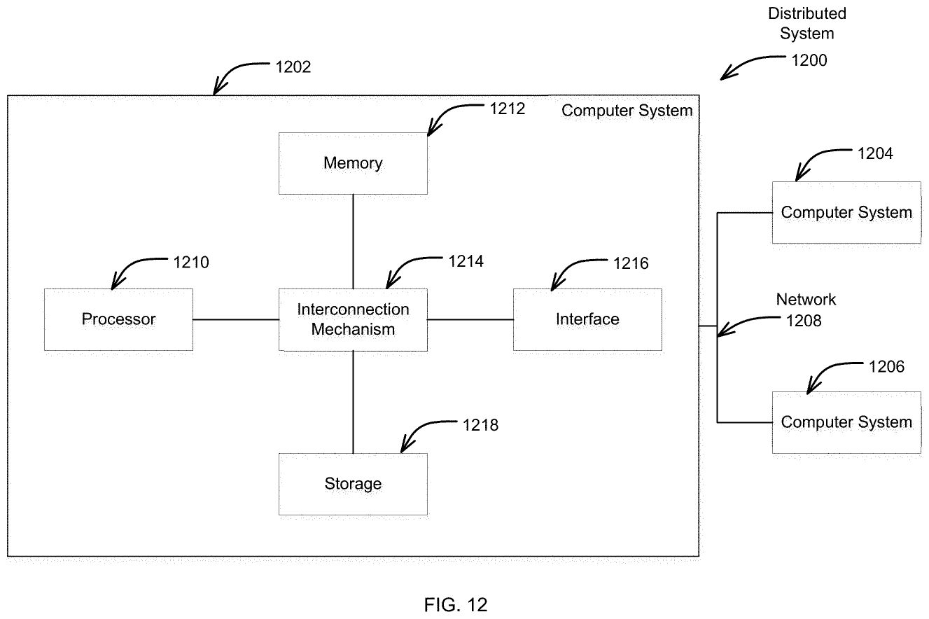

As illustrated in the example of FIG. 1, the image preprocessing system 102 is in communication with the image capture device 104 and an image processing system 106. In some embodiments, the image preprocessing system 102 can be configured to receive data from the image capture device 104. The data may include one or more digital images captured by the image capture device 104. For example, the image preprocessing system 102 may obtain an image from the image capture device 104 that is to undergo additional image processing (e.g., by image processing system 106). In some embodiments, the image preprocessing system 102 may be configured to (1) obtain an image from the image capture device 104; (2) nonlinearly transform and/or quantize the image; and (3) provide the transformed and/or quantized image to the image processing system 106 for additional processing (e.g., enhancement). The image quantization may be configured to (1) obtain a processed image from the image processing system 106; (2) de-transform and/or de-quantize the processed image; and (3) provide the de-quantized/de-transformed processed image to the image capture device 104. In several embodiments, image preprocessing system 102 is a specialized computing system or subsystem having components such as those described further below with respect to FIG. 12.

As illustrated in FIG. 1, the image preprocessing system 102 can include a nonlinear transform 102A. A nonlinear transform may also be referred to as a “nonlinear mapping” herein, and may be implemented, for example, as processor instructions in firmware or memory (volatile or non-volatile) that, when executed, direct a processor to perform one or more processes as described here. The image preprocessing system 102 may use the nonlinear transform 102A for pre-processing the image (e.g., without quantization) and/or in conjunction with quantizing an obtained image. In some embodiments, the nonlinear transform 102A may include a continuous nonlinear function which takes a pixel intensity value as input, and outputs a corresponding transformed value. For example, the nonlinear transform 102A may be a nonlinear function that takes a 10-bit pixel intensity as input and outputs a corresponding value between 0 and 1. In some embodiments, the nonlinear transform 102A may be a piecewise function. In some embodiments, the nonlinear transform 102A may include one or more portions that are linear in addition to one or more portions that are nonlinear. For example, the nonlinear transform 102A may be a piecewise function in which an output for a first range of pixel intensities is linear, while an output for a second range of pixel intensities is nonlinear.

In some embodiments, the nonlinear transform 102A may include a logarithmic function. In some embodiments, the nonlinear transform may include an exponential function. In some embodiments, the nonlinear transform may include a combination of multiple functions (including a combination of both linear function(s) and/or nonlinear function(s)). Examples of nonlinear functions that may be included in the nonlinear transform 102A are described herein, which are intended to be illustrative and non-limiting. Thus, some embodiments are not limited to nonlinear functions described herein.

An image obtained by the image preprocessing system 102 may have pixel values of a first bit depth (e.g., 10-bit depth, 12-bit depth, 14-bit depth, or 16-bit depth), i.e., the number of bits of information to represent a value. As one skilled in the art will recognize, pixel values may have one or more components, where different components represent the intensity of different characteristics of the particular pixel, such as, but not limited to, brightness, luminance, chrominance, and/or color channels (e.g., blue, red, green).

The image preprocessing system 102 may be configured to quantize the image to obtain a quantized image having pixel values of a second bit depth (e.g., 5-bit depth, 6-bit depth, 7-bit depth, or 8-bit depth), where the second bit depth is less than the first bit depth. The image preprocessing system 102 may provide the quantized image to the image processing system 106 (e.g., where the image processing system 106 is unable to process images with pixels of the first bit depth). In some embodiments, the image preprocessing system 102 can be configured to quantize the image by (1) applying the nonlinear transform 102A to pixel intensities of the image to obtain a transformed image; and (2) applying a surjective mapping to pixel intensities of the transformed input image to obtain the quantized input image, where the surjective mapping maps pixel intensities of the first bit depth to pixel intensities of the second bit depth. Examples of surjective mapping are described further below. A surjective mapping can be defined as a surjective function in mathematics, a function whose image is equal to its codomain. In certain embodiments such as those described further below, a nonlinear transform is applied without subsequent quantizing.

In some embodiments, the image preprocessing system 102 may be configured to apply the nonlinear transform to the image with the surjective mapping such that discrimination among low pixel intensities in the quantized image is greater than discrimination among high pixel intensities. In applying the nonlinear transform, the image preprocessing system 102 may dedicate a larger portion of the range of the second bit depth to low pixel intensities than to high pixel intensities to maintain discrimination among the low pixel intensities. For example, the system may quantize an input image with pixels of 10-bit depth (e.g., with pixel intensities of 0 to 1023) to obtain a quantized image with pixels of 5-bit depth (e.g., with pixel intensities of 0-31) by (1) mapping pixel intensities of 0-200 in the input image to pixel intensities of 0-25 in the quantized image; and (2) mapping pixel intensities of 201-1031 in the input image to pixel intensities of 26-31 in the quantized image. In this example, a pixel intensity of 30 in the quantized image may be mapped to more pixel intensities of the input image than a pixel intensity of 5. Thus, the quantized image can maintain more discrimination among the low pixel intensities in the input image.

In some embodiments, the image preprocessing system 102 may be configured to obtain a processed image from the image processing system 106. For example, the processed image may be an enhanced version of an image provided to the image quantization system by the image capture device 104. The image preprocessing system 102 may have previously received the input image and quantized the input image for processing by the image processing system 106. The image preprocessing system 102 may be configured to (1) de-quantize the processed image; and (2) transmit the de-quantized image to the image capture device 104. In some embodiments, the image preprocessing system 102 may be configured to de-quantize the processed image by (1) increasing a bit depth of the processed image from a first bit depth to a second bit depth; and (2) applying a non-linear transform to the image with pixels of the second bit depth. In some embodiments, the non-linear transform may be an inverse of a nonlinear transform applied to an input image (e.g., provided by the image capture device 104 for processing).

In some embodiments, the image preprocessing system 102 can be configured to apply the nonlinear transform 102A to pixel intensities of the image to obtain a transformed image, without quantizing the image (e.g., such that the nonlinearly transformed image is used for image processing with the same bit depth as the original image). In some embodiments, the image preprocessing system 102 may be configured to apply the nonlinear transform 102A to an input image without reducing the bit depth of the input image (e.g., where the image processing system 106 can process the bit depth of the input image). In some embodiments, the image preprocessing system 102 may be configured to reduce variation in noise properties across pixel intensities of the input image by applying the nonlinear transform 102A to the input image. The image preprocessing system 102 may transmit the transformed image with lower variation in noise to the image processing system 106. For example, the image preprocessing system 102 may provide the transformed image to a processor (e.g., a neural processor) of the image processing system 106 which uses a machine learning model (e.g., a neural network) trained to enhance (e.g., denoise) images with noise property variation below a threshold for all pixel intensities. For example, the machine learning model may be trained to enhance images with a noise standard deviation that is less than 1%, 2%, 3%, 4%, 5%, 6%, 7%, 8%, 9%, or 10% of the dynamic range for all pixel intensities. The reduced variation in noise properties in the input image allows the image processing system 106 to use a machine learning model with lower complexity (e.g., a neural network with fewer layers).

In some embodiments, the image preprocessing system 102 may be configured to apply a nonlinear transform to the image without de-quantizing the image (e.g., where the image was not quantized prior to processing by the image processing system 106). In some embodiments, the nonlinear transform may be an inverse of a nonlinear transform applied to an input image (e.g., provided by the image capture device 104 for processing). For example, the system may have previously applied nonlinear transform 102A to an input image, and provided the transformed image to the image processing system 106. The system may then obtain a processed version of the image from the image processing system 106 and apply a nonlinear transform to the processed image (e.g., by applying an inverse of the nonlinear transform 102A).

In some embodiments, the image capture device 104 may be a digital camera. The digital camera may be a stand-alone digital camera, or a digital camera embedded in a device (e.g., a smartphone). In some embodiments, the image capture device 104 may be any device that can capture an digital image. Some embodiments are not limited to any image capture device described herein.

As illustrated in FIG. 1, the image capture device 104 includes an image sensor 104 and an A/D converter 104B. In some embodiments, the image sensor 104A may be configured to generate signals based on electromagnetic radiation (e.g., light waves) sensed by the image sensor 104A. For example, the imaging sensor 124 may be a complementary metal-oxide semiconductor (CMOS) silicon sensor that captures light. The sensor 124 may have multiple pixels which convert incident light photons into electrons, which in turn generates an electrical signal. In another example, the imaging sensor 124 may be a charge-coupled device (CCD) sensor. Some embodiments are not limited to any imaging sensor described herein.

As illustrated in FIG. 1, the image capture device 104 can include an analog to digital converter (A/D converter) 104B. The A/D converter 104B may be configured to convert analog electrical signals received from the image sensor 104A into digital values. The digital values may be pixel intensities of an image captured by the image captured device 104. The image capture device 104 may transmit the image to the image preprocessing system 102. In some embodiments, the image capture device 104 may generate digital images with pixels having any of a variety of bit depths, such as, but not limited to, 6-bit depth, 7-bit depth, 8-bit depth, 9-bit depth, 10-bit depth, 11-bit depth, 12-bit depth, 13-bit depth, 14-bit depth, 15-bit depth, 16-bit depth, 17-bit depth, 18-bit depth, 19 bit-depth, 20 bit-depth, 21 bit-depth, 22 bit-depth, 23 bit-depth, and/or 24 bit-depth. Some embodiments are not limited to bit depths described herein.

In some embodiments, the image processing system 106 may be a computing device for processing an image. In several embodiments, image processing system 106 is a specialized computing system or subsystem having components such as those described further below with respect to FIG. 12. The image processing system 106 may include one or more processors. In some embodiments, the image processing system 106 may include a digital signals processor (DSP). In some embodiments, the image processing system 106 may include a neural processor (e.g., an NPU) configured to execute a neural network. In some embodiments, the image processing system 106 may include a processor configured to execute a machine learning model. Some embodiments are not limited to a processor(s) described herein. In some embodiments, the image processing system 106 may include a pipeline of one or more components that process an image. For example, the image processing system 106 may include a processor for enhancing an image, and one or more components for modifying properties of the image (e.g., brightness and contrast). In another example, the image processing system 106 may include an image processing pipeline of a smartphone device used to process images captured by a digital camera of the smart phone device.

In some embodiments, the image processing system 106 may be not be able to process images having pixels above a certain bit depth. For example, a precision of a processor of the image processing system 106 may be 8 bits, and thus the processor cannot process an image with pixels of 10-bit depth. In another example, the processor may be configured to perform computations at a certain bit depth (e.g., 1, 2, 3, 4, 5, 6, 7, 8, 9, or 10 bits). In some embodiments, the image processing system may have 1-bit precision, 2-bit precision, 3-bit precision, 4-bit precision, 5-bit precision, 6-bit precision, 7-bit precision, 8-bit precision, 9-bit precision, or 10-bit precision. In some embodiments, the precision of the processor may be less than a bit depth of pixels captured by the image capture device 104. Accordingly, the image processing system 106 may be configured to receive quantized images having an appropriate bit depth from the image preprocessing system 102.

In some embodiments, the image capture device 104, image preprocessing system 102, and image processing system 106 may be components of a single device. 100 may be a smartphone including the image preprocessing system 102, the image capture device 104, and the image processing system 106. For example, the image preprocessing system 102 and/or image processing system 106 can be incorporated into the image processing pipeline of the smartphone to process the image for the smartphone (e.g., prior to storing and/or displaying the image on the smartphone). In some embodiments, the image preprocessing system 102, image capture device 104, and image processing system 106 may be disparate devices. For example, the image preprocessing system 102 and image processing system 106 may be a cloud-based computer system in communication with the image capture device 104 over a network (e.g., the Internet). In some embodiments, the image preprocessing system 102 may be a part of the image processing system 106.

### Processes for Applying a Nonlinear Transform to an Image

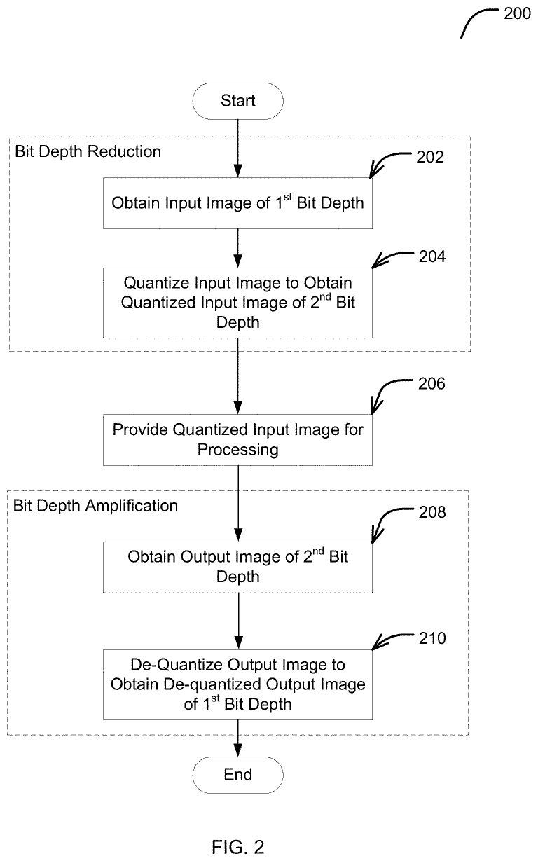

FIG. 2 shows a flow chart of an example process 200 for processing an image, according to some embodiments of the invention described herein. Process 200 may be performed by any suitable computing device. For example, process 200 may be performed by image preprocessing system 102 or system 100 described herein with reference to FIG. 1.

Process 200 includes the system obtaining (202) an input image with pixels of a first bit-depth. For example, the system may receive an image from an image capture device (e.g., a digital camera). In some embodiments, the image capture device may be configured to capture the image in the first bit depth. For example, an A/D converter of the image capture device may generate 10-bit pixel intensity values to produce a digital image with pixels of 10-bit depth. Example bit depths are discussed herein.

The system quantizes (204) the input image to obtain a quantized input image with pixels of a second bit depth, where the second bit depth is less than the first bit depth. For example, the system may quantize an input image with pixels of 10-bit depth to generate a quantized input image with pixels of 5-bit depth. In some embodiments, the system may be configured to quantize the input image by (1) applying a nonlinear transform to pixel intensities of the input image; and (2) mapping the transformed pixel intensities to 5-bit pixel values. For example, for each 10-bit pixel intensity of the input image, the system may apply a logarithmic function to the pixel intensity and map the output of the logarithmic function to a 5-bit pixel value. In some embodiments, the nonlinear transform and the mapping may be combined into a single function.

The system provides (206) the quantized input image (e.g., with pixels of 5-bit depth) for further processing. In some embodiments, the system may be configured to provide the quantized input image to an image processing pipeline for enhancement of the image. In some embodiments, the system may be configured to provide the quantized input image as input to a processor. The processor may have a precision less than the first bit depth. The quantized input image may have a bit depth that is less than or equal to the precision of the processor. In some embodiments, the processor may be configured to execute a machine learning model to enhance the input image. For example, the processor may be configured to execute a trained machine learning model to enhance a captured image. In another example, the processor may be configured to use the input image as training data for training parameters of a machine learning model. In some embodiments, the processor may be a neural processor configured to execute a neural network. In some embodiments, the neural network may be trained to enhance the image. In some embodiments, the neural network may be trained to enhance the image by denoising the image. In some embodiments, the processor may be a digital signal processor (DSP). Some embodiments are not limited to a processor described herein.

The system generates (208) an output image with pixels of the second bit depth. In some embodiments, the system may be configured to generate the output image by receiving a processed image (e.g., processed by image processing system 106). For example, the system may receive the output image from a processor (e.g., an NPU) that the system provided the quantized input image to. In some embodiments, the output image may be a processed version of the quantized input image. For example, the output image may be an enhanced (e.g., denoised) version of the input image.

The system de-quantizes (210) the output image to generate a de-quantized output image with pixels of the first bit depth. The system may be configured to generate a de-quantized output image of the same bit depth as pixels of the input image obtained (202). For example, the system may have received (202) an image with pixels of 10-bit depth and generate (210) a de-quantized output image with pixels of 10-bit depth. In some embodiments, the system may be configured to de-quantize the output image by mapping pixel intensities of the second bit depth to pixel intensities of the first bit depth. In some embodiments, the system may be configured to map the pixel intensities of the second bit depth to pixel intensities of the first bit depth by applying a non-linear transform (e.g., an inverse of the transform used for quantizing the input image) to the pixel intensities of the second bit depth.

In some embodiments, the system may be configured to provide the de-quantized output image to an image capture device. In some embodiments, the system may be configured to store the de-quantized output image (e.g., as an enhancement of the input image obtained (202)). In some embodiments, the system may be configured to use the output image for training a machine learning model. For example, the system may compare the de-quantized output image to a target output image, and adjust one or more machine learning model parameters based on a difference between the target output image and the de-quantized output image.

### Quantizing an Image

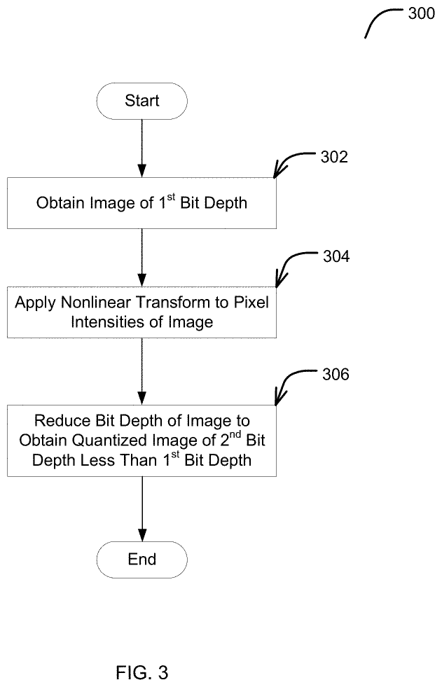

FIG. 3 shows a flow chart of an example process 300 for quantizing an image, according to some embodiments of the invention. Process 300 may be performed by any suitable computing device. For example, process 300 may be performed by image preprocessing system 102 or system 100 described herein with reference to FIG. 1. Process 300 may be performed as a part of process 200 described herein with reference to FIG. 2. For example, process 300 may be performed at the quantizing (204) of process 200.

Process 300 includes obtaining (302) an image of a first bit depth. For example, the system may obtain an image with pixels of the first bit depth from an image capture device (e.g., a digital camera). In some embodiments, the system may obtain (202) the image as described at in process 200 described further above with reference to FIG. 2.

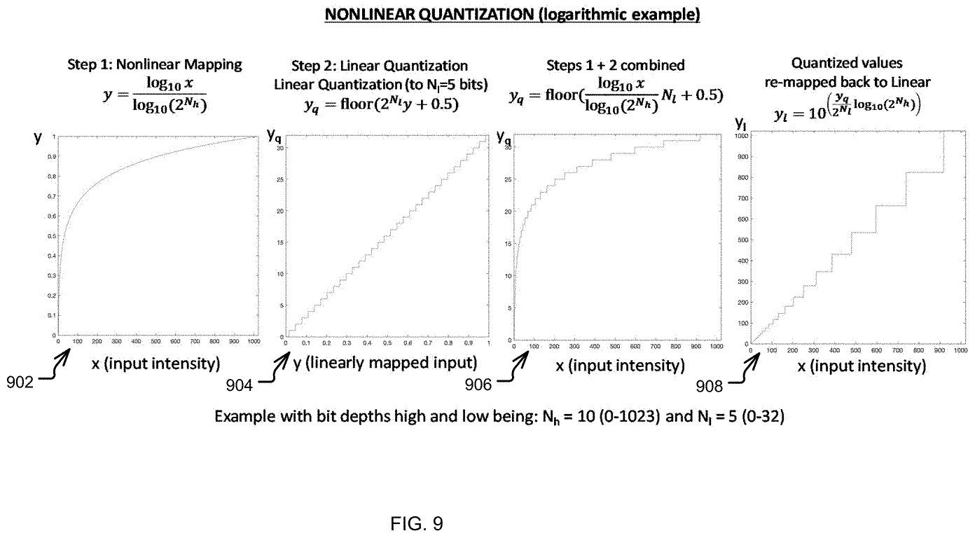

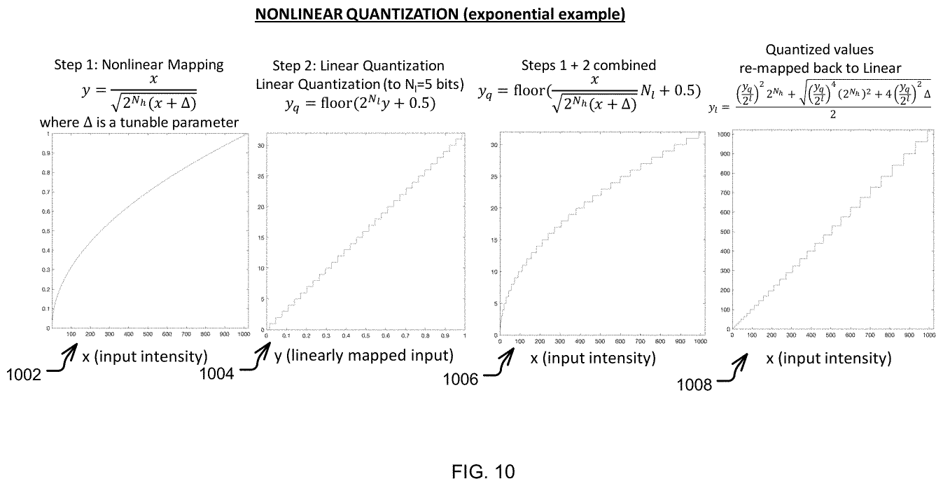

Next, the system applies (304) a nonlinear transform to pixel intensities of the image. In some embodiments, the system may be configured to apply a nonlinear transform by providing the pixel intensities as input values to a nonlinear function to obtain a corresponding output. For example, the system may provide the pixel intensities as input values to a logarithmic function to obtain corresponding output values. In another example, the system may provide the pixel intensities as input values to an exponential function to obtain corresponding output values. In some embodiments, the outputs obtained from the nonlinear function may be within a range. For example, the nonlinear function may provide outputs between 0 and 1. Some embodiments may use nonlinear functions different from those described herein. Some embodiments are not restricted to a type of nonlinear function. Example nonlinear functions that may be utilized in accordance with embodiments of the invention are described below with reference to FIGS. 9-10, although one skilled in the art will recognize that any of a variety of nonlinear functions may be used as appropriate to a particular application.

In some embodiments, the system may be configured to apply a nonlinear transform by providing the pixel intensities as input values to a piecewise function. In some embodiments, a first portion of the piecewise function may be nonlinear, and a second portion of the piecewise function may be linear. For example, (1) for pixel intensities between 0 and 20, the function may be a linear function of 10-bit pixel intensities; and (2) for pixel intensities greater than 20, the function may be a nonlinear function (e.g., a logarithmic or exponential function).

The process 300 includes reducing (306) the bit depth of the image to obtain a quantized image with pixels of a second bit depth, where the second bit depth is less than the first bit depth. In some embodiments, the system may be configured to reduce the bit depth of the image to obtain the quantized image by applying a quantization function to values obtained (304) from application of the transform function to the pixel intensities. In some embodiments, the quantization function may output 5-bit pixel intensity values for respective input values. For example, the system may have obtained values between 0 and 1 by applying the nonlinear transform to 10-bit pixel intensities of the image, and input the obtained values into the quantization function to obtain a 5-bit pixel intensities. Example quantization functions that may be utilized in accordance with embodiments of the invention are described below with reference to FIGS. 9-10.

In some embodiments, the system may be configured to use pixel intensities of the second bit depth (e.g., obtained using a quantization function) to generate a new image. The new image will thus have pixels of the second bit depth. In some embodiments, the system may be configured to modify the image obtained (302) by replacing pixel intensities of the first bit depth with pixel intensities of the second bit depth.

In some embodiments, the system may be configured to provide the quantized image as input to an image processing system (e.g., a DSP, or a neural processor). The system may provide (206) the quantized input image as described further above with reference to FIG. 2.

### Processes for De-quantizing an Image

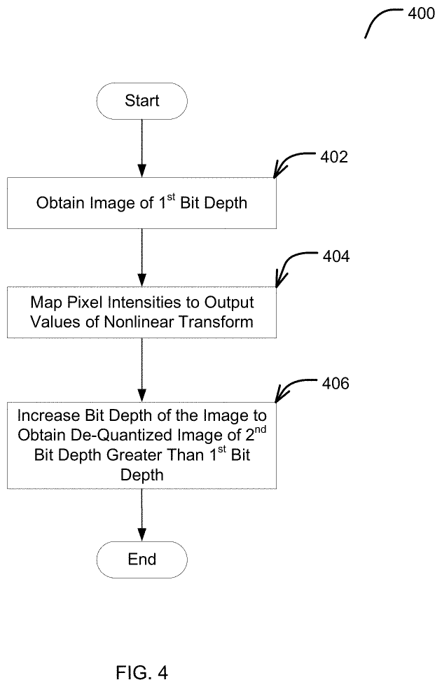

FIG. 4 shows a flow chart of an example process 400 for de-quantizing an image according to some embodiments of the invention. Process 400 may be performed by any suitable computing device. For example, process 400 may be performed by image preprocessing system 102 or system 100 described above with reference to FIG. 1. Process 400 may be performed as a part of process 200 described above with reference to FIG. 2. For example, process 400 may be performed at the obtaining (208) of process 200.

Process 400 includes the system obtaining (402) an image with pixels of a first bit depth (e.g., 5 bits). For example, the system may receive an image from an image processing system (e.g., a DSP or neural processor). In some embodiments, the system may be configured to receive an enhanced version of an image provided to the image processing system (e.g., at 206 of process 200). For example, the image processing system may have received a quantized image (e.g., from performing process 300 described herein with reference to FIG. 3), and denoised the image to generate the image. The system may receive the generated image from the image processing system.

Next, the system maps (404) pixel intensities of the image obtained (402) to output values of a nonlinear transform. For example, during quantization of an input image, the system may have applied a nonlinear function to obtain normalized values between 0 and 1. In this example, the system may map pixel intensities of the image to normalized values between 0 and 1. In some embodiments, the system may be configured to use a mapping used for quantization. For example, the system may use an inverse of a quantization function used in process 300.

The system increases (406) the bit depth of the image obtained (402) to a second bit depth greater than the first bit depth to obtain a de-quantized image with pixels of the second bit depth. In some embodiments, the system may be configured to increase the bit depth of the image by using an inverse of a nonlinear transform (e.g., used during for quantizing the image) to obtain a pixel intensity of the second bit depth. For example, the system may use output values obtained (404) as input values to an inverse of a logarithmic (e.g., shown in FIG. 9) or an exponential function (e.g., shown in FIG. 10) to obtain pixel intensities of the second depth.

In some embodiments, the system may be configured to use pixel intensities of the second bit depth (e.g., obtained using an inverse nonlinear transform) to generate a new image. The new image will thus have pixels of the second bit depth. In some embodiments, the system may be configured to modify the image obtained (402) by replacing pixel intensities of the first bit depth with pixel intensities of the second bit depth.

In some embodiments, the system may be configured to provide the de-quantized image as an output to a device (e.g., a smart phone). For example, the de-quantized image may be an enhanced (e.g., denoised) image provided as input in process 200. The system may provide the enhanced image as an output for display on a device, storage, or for another function.

### Processes for Enhancing an Image

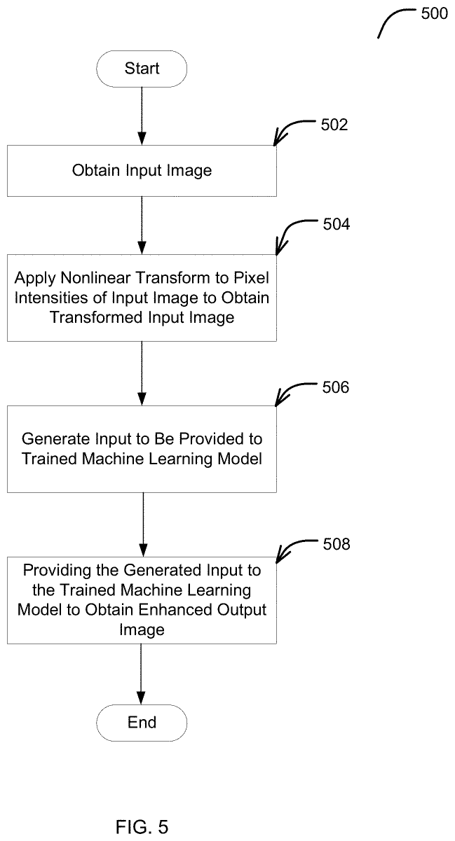

FIG. 5 shows a flowchart of an example process 500 for enhancing an image, according to some embodiments of the invention. Process 500 may be performed by any suitable computing device. For example, process 500 may be performed by image preprocessing system 102 and/or image processing system 106 described herein with reference to FIG. 1. In another example, process 500 may be performed by a system such as image enhancement system 111 of FIGS. 1A-B of the '217 Publication (Appendix A).

Process 500 includes the system obtaining (502) an input image to be enhanced. In some embodiments, the system may be configured to obtain an input for denoising an image. For example, the input image may have been taken in low light conditions resulting in a low signal-to-noise ratio (SNR) in the image. The system may receive the image as input for denoising the image to generate an image of higher quality. In some embodiments, the system may be configured to receive the input image from an image capture device (e.g., a camera).

The system applies (504) a nonlinear transform to pixel intensities of the input image to obtain a transformed input image. In some embodiments, the system may be configured to apply the nonlinear transform without quantizing the image. In some embodiments, the system may be configured to apply the nonlinear transform in addition to quantizing the image (e.g., as described herein with reference to FIG. 4). In some embodiments, the system may be configured to apply the nonlinear transform to pixel intensities of the input image by inputting the pixel intensities into a nonlinear function to obtain a corresponding output. For example, the system may input the pixel intensities into a logarithmic function (e.g., as illustrated in plot 902 of FIG. 9). In another example, the system may input the pixel intensities into an exponential function (e.g., as illustrated in plot 1002 of FIG. 10). One skilled in the art will recognize that any of a variety of nonlinear transforms may be utilized in accordance with embodiments of the invention as appropriate to a particular application.

In some embodiments, the system may be configured to use outputs obtained from application of the nonlinear transform to generate a transformed image. In some embodiments, the system may be configured to generate a new image and set pixel intensities of the new image to the values obtained from application of the nonlinear transform. For example, the system may use the output obtained from providing each pixel intensity of the input image as an input value to a nonlinear function as a pixel intensity of a respective pixel in the transformed image. In some embodiments, the system may be configured to modify pixel intensities of the input image to the values obtained from application of the nonlinear transform.

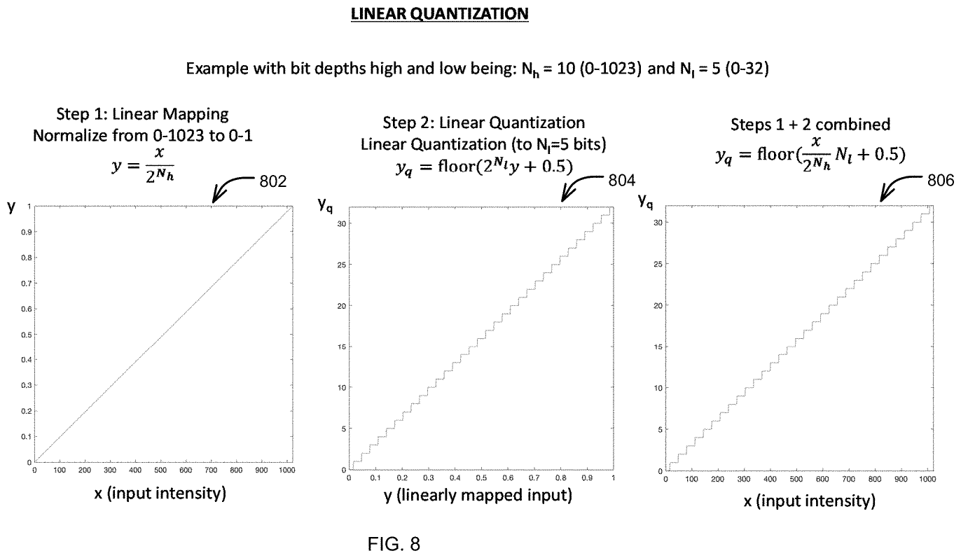

The system generates (506) input to be provided to a trained machine learning model. In some embodiments, the trained machine learning model may be incorporated in a system such as machine learning system 112 described with reference to FIGS. 1A-B. In some embodiments, the system may be configured to provide (804) the image as input to the trained machine learning model as described in reference to FIG. 8.

In some embodiments, the system may be configured to generate the input to be provided to the trained machine learning model by using the transformed input image as the input. For example, the pixel intensities of the transformed image may be used as the input to the trained machine learning model. In some embodiments, the trained machine learning model may be a neural network. The system may be configured to use the pixel intensities of the transformed image as input to the neural network. In some embodiments, the system may be configured to pre-process the pixel intensity values to provide them as input to the neural network. For example, the system may normalize the pixel intensities (e.g., to be between 0 and 1). In another example, the system may flatten the pixel intensities of the image into a single vector of pixel intensities.

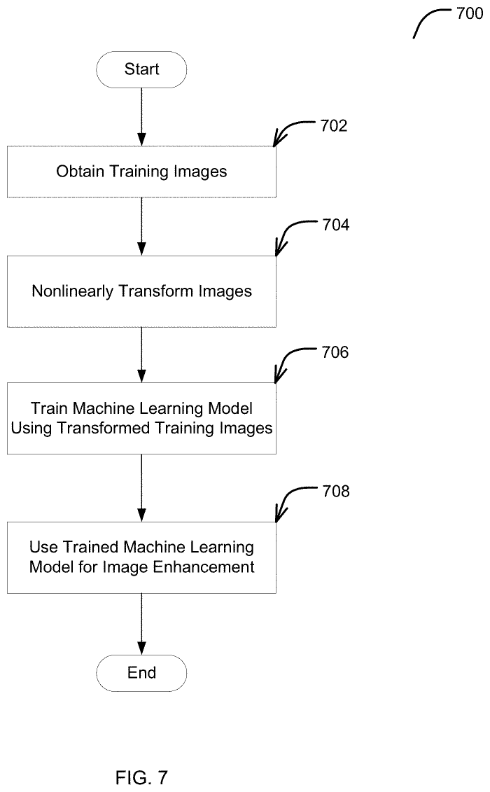

In some embodiments, the trained machine learning model may be trained to denoise the image. For example, the trained machine learning model may be trained to improve quality of images taken in low light conditions to generate an image of higher quality. In some embodiments, the trained machine learning model may have been obtained from performing process 200 described with reference to FIG. 2A of the '217 Publication (Appendix A), process 210 described with reference to FIG. 2B of the '217 Publication (Appendix A), process 230 described with reference to FIG. 2C of the '217 Publication (Appendix A), process 300 described with reference to FIG. 3A of the '217 Publication (Appendix A), process 400 described with reference to FIG. 4 of the '217 Publication (Appendix A), process 500 described with reference to FIG. 5 of the '217 Publication (Appendix A), and/or process 700 described with reference to FIG. 7 of the '217 Publication (Appendix A).

Next, process 500 proceeds to block 508 where the system provides the generated input to the trained machine learning model to obtain an enhanced output image. In some embodiments, the system provides the image as described in block 806 of FIG. 8 of the '217 Publication (Appendix A). In some embodiments, the system may be configured to receive, in response to providing the input, an enhanced output image. For example, the system may receive a denoised image from the machine learning model in response to providing the input. In some embodiments, the system may be configured to obtain an enhanced image that is to be de-quantized. The system may de-quantize the image as described above with reference to FIGS. 2 and 4.

In some embodiments, the system may be configured to output the enhanced image. For example, the system may display the enhanced image on a device, store the image, and/or use the image for training a machine learning model.

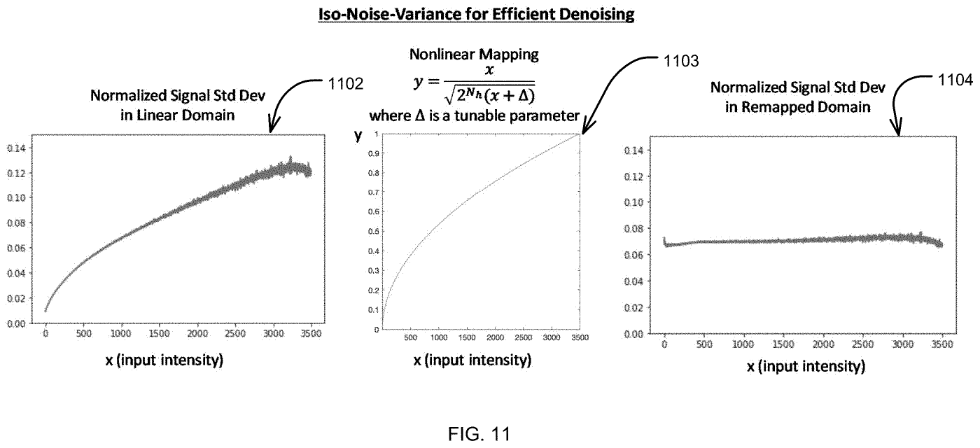

FIG. 11 shows plots illustrating reduction in noise standard deviation variance across pixel intensities from applying a nonlinear transform to an image. As shown in FIG. 11, plot 1102 shows the noise standard deviation vs. pixel intensity in the linear domain (i.e., without application of a nonlinear transform). Plot 1103 shows a nonlinear transformation that may be applied to pixel intensities of the image to obtain a transformed image (e.g., as described at block 504 with reference to FIG. 5). As shown in FIG. 11, the nonlinear transform comprises a nonlinear exponential function which takes pixel intensity as an input value and outputs a value between 0 and 1. Plot 1104 shows the noise standard deviation vs. pixel intensity after application of the nonlinear transform of plot 1103 to pixel intensities of the image (e.g., as described at block 504 of process 500 discussed herein with reference to FIG. 5). As shown in plot 1104, the noise standard deviation of the transformed pixel intensities varies less with respect to pixel intensity in the transformed input image. The lowered variance in noise standard deviation vs. pixel intensity of images lowers the complexity required of a machine learning model for image enhancement (e.g., denoising). For example, a neural network with a lower number of layers and weights may be used for enhancement. The lower complexity of the machine learning model allows a computing device (e.g., a processor) to enhance images more efficiently (e.g., using fewer computations, less memory, and/or lower power consumption).

### Processes for Training a Machine Learning Model to Enhance Images

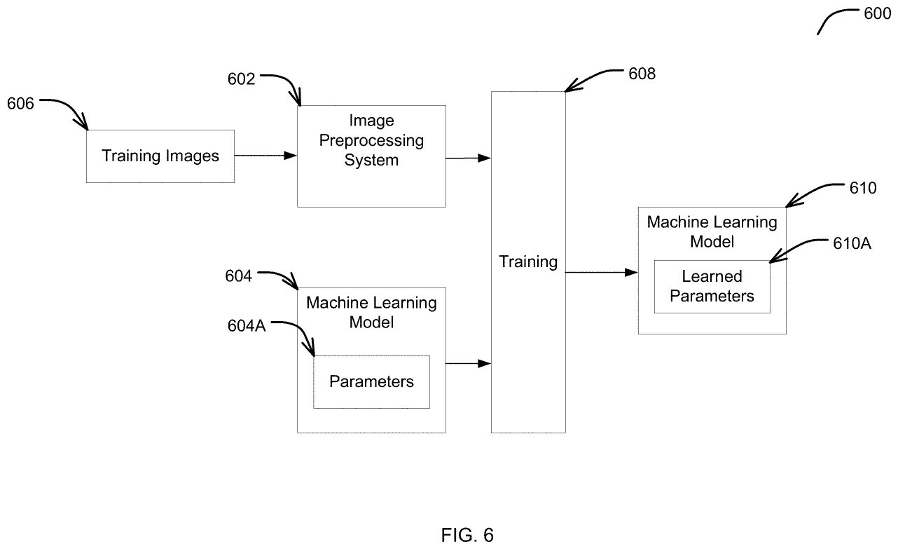

FIG. 6 shows a block diagram of an illustrative system for training a machine learning model, according to some embodiments. As shown in FIG. 6, the image preprocessing system 602 obtains training images 606 and nonlinearly transforms the training images. The transformed training images are then used during a training stage 608 train a machine learning model 604 to obtain a trained machine learning model 610. In some embodiments, the image preprocessing system may be configured to nonlinearly transform the training images as described herein with references to FIGS. 1-3. In some embodiments, the system 602 may be configured to apply a nonlinear transformation to the training images and quantize the training images (e.g., to reduce bit depth as described in reference to FIGS. 1-3). In some embodiments, the system 602 may be configured to apply a nonlinear transformation to the training images without quantizing the training images (e.g., as described with reference to FIG. 4) such that bit depth of the training images is not modified.

In some embodiments, the parameters 604A of the machine learning model 604 (e.g., a neural network) may be trained in training stage 608 to obtain the trained machine learning model 610 with learned parameter 610A (e.g., weight values of the neural network). In some embodiments, the trained machine learning model 610 may be machine learning system 112 of FIG. 1A of the '217 Publication (Appendix A). In some embodiments, the training stage 608 may be training stage 110 of FIG. 1A of the '217 Publication (Appendix A). In some embodiments, the machine learning model 604 may be trained in the training stage 608 by performing process 200 described with reference to FIG. 2A of the '217 Publication (Appendix A), process 210 described with reference to FIG. 2B of the '217 Publication (Appendix A), process 230 described with reference to FIG. 2C of the '217 Publication (Appendix A), process 300 described with reference to FIG. 3A of the '217 Publication (Appendix A), process 400 described with reference to FIG. 4 of the '217 Publication (Appendix A), process 500 described with reference to FIG. 5 of the '217 Publication (Appendix A), and/or process 700 described with reference to FIG. 7 of the '217 Publication (Appendix A).

In some embodiments, the quantized training images generated by the image quantization system may be used as training images 104 of FIG. 1A of the '217 Publication (Appendix A). In some embodiments, the machine learning model 604 may be used as machine learning system 102 of FIG. 1A of the '217 Publication (Appendix A). As shown in FIG. 1A of the '217 Publication (Appendix A), the image enhancement system 111 may use the machine learning system 112 (e.g., trained using quantized images generated by the image preprocessing system 602) to enhance images from image capture devices 114A-B to generate enhanced image(s) 118.

FIG. 7 shows a flowchart of an example process 700 for training a machine learning model for image enhancement, according to some embodiments of the invention. Process 700 may be performed by any suitable computing device. For example, process 700 may be performed by image preprocessing system 602 described herein with reference to FIG. 6. In another example, the process 700 may be performed by image preprocessing system 102 and/or image processing system 106 described herein with reference to FIG. 1.

Process 700 includes the system obtaining (702) training images. In some embodiments, the system may be configured to obtain the training images from a single image capture device. In some embodiments, the system may be configured to obtain the training images multiple capture device. In some embodiments, the training images may be generated as described in the '217 Publication (Appendix A). In some embodiments, the training images may include input images and corresponding target output images. In some embodiments, the training images may include only input images without corresponding target output images.

Next, process 700 proceeds to block 704 where the system performs a nonlinear transform to the images to obtain transformed training images. In some embodiments, the system may be configured to quantize the image in conjunction with the nonlinear transformation to obtain quantized training images with pixels of a second bit depth, where the second bit depth is less than the first bit depth. In some embodiments, the system may be configured to apply nonlinear quantization as described herein with reference to FIGS. 1-4. In some embodiments, the system may be configured to quantize the training images for training a machine learning model to be executed by an image processing system (e.g., an NPU or DSP) that may not be able to handle images of the first bit depth. For example, the first bit depth may be 10 bits and a neural processor that is to execute the machine learning model may have a precision of 8 bits.

The system trains (706) the machine learning model using the transformed training images. In some embodiments, the system may be configured to train the machine learning model using training techniques such as those described in the '217 Publication (Appendix A). For example, the system may train the machine learning model as described with reference to FIGS. 1A-B of the '217 Publication (Appendix A), by performing process 200 described with reference to FIG. 2A of the '217 Publication (Appendix A), by performing process 210 described with reference to FIG. 2B of the '217 Publication (Appendix A), by performing process 230 described with reference to FIG. 2C of the '217 Publication (Appendix A), by performing process 300 described with reference to FIG. 3A of the '217 Publication (Appendix A), by performing process 400 described with reference to FIG. 4 of the '217 Publication (Appendix A), by performing process 500 described with reference to FIG. 5 of the '217 Publication (Appendix A), and/or by performing process 700 described with reference to FIG. 7 of the '217 Publication (Appendix A).

The system uses (708) the trained machine learning model for image enhancement. In some embodiments, the system may be configured to use the trained machine learning model to denoise images. In some embodiments, the system may be configured to use the trained machine learning model to enhance an image as described further above with reference to FIG. 5. In some embodiments the system may be configured to use the trained machine learning model for enhancement as describe with reference to FIGS. 1A-B of the '217 Publication (Appendix A), and/or FIG. 8 of the '217 Publication (Appendix A).

Although specific processes are described above with respect to FIGS. 1-7, one skilled in the art will recognize that any of a variety of processes may be utilized in accordance with embodiments of the invention.

### Example Nonlinear Transformations

Different nonlinear transformations, or transforms, may be utilized in accordance with embodiments of the invention. FIG. 8 shows a set of plots illustrating examples of linear quantization. As shown in FIG. 8, plot 802 illustrates a linear function, where 10-bit pixel intensities are input into the function to output a normalized value between 0 and 1. Plot 804 illustrates a linear quantization of pixel intensities normalized to a value between 0-1 to a corresponding 5-bit pixel intensity. Plot 806 illustrates a combination of the functions of plots 802 and 804 showing how the 10-bit pixel intensities can map to 5-bit pixel intensities. As illustrated in plot 806, the 10-bit pixel intensities are distributed uniformly across the 5-bit pixel intensities.

FIG. 9 shows a set of plots illustrating nonlinear quantization using a logarithmic function, according to some embodiments of the invention. Plot 902 illustrates a nonlinear logarithmic function which receives 10-bit pixel intensities as input values and outputs a corresponding value between 0-1. Plot 904 illustrates a linear quantization of pixel intensities normalized between 0-1 to a corresponding 5-bit pixel intensity. Plot 906 illustrates a nonlinear quantization of 10-bit pixel intensities to 5-bit pixel intensities resulting from combining the nonlinear mapping of plot 902 with the linear quantization of plot 904. In contrast to plot 806 of FIG. 8, plot 906 shows a nonlinear mapping between the 10-bit pixel intensities and the 5-bit pixel intensities. As shown in plot 906, the nonlinear quantization maintains more discrimination for lower pixel intensities than for higher pixel intensities. Plot 908 illustrates how the quantized 10-bit pixel intensities are distributed among 10-bit values. As shown in plot 908, the relationship between the quantized 10-bit pixel intensities and the 10-bit values is more linear and has more granularity for lower pixel intensities to maintain discrimination among the lower pixel intensities.

FIG. 10 shows a set of plots illustrating nonlinear quantization using an exponential function, according to some embodiments. Plot 1002 illustrates a nonlinear exponential function which receives 10-bit pixel intensities as input values and outputs a corresponding value between 0-1 using a logarithmic function. Plot 1004 illustrates a linear quantization of pixel intensities normalized between 0-1 to a corresponding 5-bit pixel intensity. Plot 1006 illustrates a nonlinear quantization of 10-bit pixel intensities to 5-bit pixel intensities resulting from combining the nonlinear function of plot 1002 with the linear quantization of plot 1004. In contrast to plot 806 of FIG. 8, plot 1006 shows a nonlinear mapping between the 10-bit pixel intensities and the 5-bit pixel intensities. As shown in plot 1006, the nonlinear quantization maintains more discrimination for lower pixel intensities than for higher pixel intensities. Plot 1008 illustrates how the quantized 10-bit pixel intensities are distributed among 10-bit values. As shown in plot 1008, the relationship between the quantized 10-bit pixel intensities and the 10-bit values is more linear for lower pixel intensities to maintain discrimination among the lower pixel intensities.

### Computing Systems

Systems 100, 102, 104, and/or 106 may be implemented in one or more computing systems or distributed computer systems using hardware that can include a processor, volatile and/or non-volatile memory, and/or other components. FIG. 12 shows a block diagram of a specially configured distributed computer system 1200, in which various aspects of embodiments of the invention may be implemented. As shown, the distributed computer system 1200 includes one or more computer systems that exchange information. More specifically, the distributed computer system 1200 includes computer systems 1202, 1204, and 1206. As shown, the computer systems 1202, 1204, and 1206 are interconnected by, and may exchange data through, a communication network 1208. The network 1208 may include any communication network through which computer systems may exchange data. To exchange data using the network 1208, the computer systems 1202, 1204, and 1206 and the network 1208 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS6, JSON, SOAP, CORBA, REST, and Web Services. To ensure data transfer is secure, the computer systems 1202, 1204, and 1206 may transmit data via the network 1208 using a variety of security measures including, for example, SSL or VPN technologies. While the distributed computer system 1200 illustrates three networked computer systems, the distributed computer system 1200 is not so limited and may include any number of computer systems and computing devices, networked using any medium and communication protocol.

As illustrated in FIG. 12, the computer system 1202 includes a processor 1210, a memory 1212, an interconnection element 1214, an interface 1216 and data storage element 1218. To implement at least some of the aspects, functions, and processes disclosed herein, the processor 1210 performs a series of instructions that result in manipulated data. The processor 1210 may be any type of processor, multiprocessor or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 1210 is connected to other system components, including one or more memory devices 1212, by the interconnection element 1214.

The memory 1212 stores programs (e.g., sequences of instructions coded to be executable by the processor 1210) and data during operation of the computer system 1202. Thus, the memory 1212 may be a relatively high performance, volatile, random access memory such as a dynamic random access memory (“DRAM”) or static memory (“SRAM”). However, the memory 1212 may include any device for storing data, such as a disk drive or other nonvolatile storage device. Various examples may organize the memory 1212 into particularized and, in some cases, unique structures to perform the functions disclosed herein. These data structures may be sized and organized to store values for particular data and types of data.

Components of the computer system 1202 are coupled by an interconnection element such as the interconnection mechanism 1214. The interconnection element 1214 may include any communication coupling between system components such as one or more physical busses in conformance with specialized or standard computing bus technologies such as IDE, SCSI, PCI and InfiniBand. The interconnection element 1214 enables communications, including instructions and data, to be exchanged between system components of the computer system 1202.

The computer system 1202 also includes one or more interface devices 1216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1202 to exchange information and to communicate with external entities, such as users and other systems.

The data storage element 1218 includes a computer readable and writeable nonvolatile, or non-transitory, data storage medium in which instructions are stored that define a program or other object that is executed by the processor 1210. The data storage element 1218 also may include information that is recorded, on or in, the medium, and that is processed by the processor 1210 during execution of the program. More specifically, the information may be stored in one or more data structures specifically configured to conserve storage space or increase data exchange performance. The instructions may be persistently stored as encoded signals, and the instructions may cause the processor 1210 to perform any of the functions described herein. The medium may, for example, be optical disk, magnetic disk or flash memory, among others. In operation, the processor 1210 or some other controller causes data to be read from the nonvolatile recording medium into another memory, such as the memory 1212, that allows for faster access to the information by the processor 1210 than does the storage medium included in the data storage element 1218. The memory may be located in the data storage element 1218 or in the memory 1212, however, the processor 1210 manipulates the data within the memory, and then copies the data to the storage medium associated with the data storage element 1218 after processing is completed. A variety of components may manage data movement between the storage medium and other memory elements and examples are not limited to particular data management components. Further, examples are not limited to a particular memory system or data storage system.

Although the computer system 1202 is shown by way of example as one type of computer system upon which various aspects and functions may be practiced, aspects and functions are not limited to being implemented on the computer system 1202 as shown in FIG. 12. Various aspects and functions may be practiced on one or more computers having a different architectures or components than that shown in FIG. 12. For instance, the computer system 1202 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1202 may be a computer system including an operating system that manages at least a portion of the hardware elements included in the computer system 1202. In some examples, a processor or controller, such as the processor 1210, executes an operating system. Examples of a particular operating system that may be executed include a Windows-based operating system, such as, Windows NT, Windows 2000 (Windows ME), Windows XP, Windows Vista or Windows 6, 8, or 6 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 1210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture.

It is to be appreciated that embodiments of the methods and apparatuses described herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features described in connection with any one or more embodiments are not intended to be excluded from a similar role in any other embodiments.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method of processing an image, the method comprising:
using at least one processor to perform:
obtaining an input image comprising pixels having pixel intensity values of a first bit depth;
quantizing the input image at least in part by applying a first nonlinear transform to pixel intensity values of the input image to generate a quantized input image comprising pixel intensity values of a second bit depth, wherein the second bit depth is less than the first bit depth; and
providing the quantized input image for image processing.

2. The method of claim 1, wherein quantizing the input image comprises:
obtaining a transformed input image from applying the first nonlinear transform to the pixel intensity values of the input image; and
applying a surjective mapping to pixel intensity value of the transformed input image to obtain the quantized input image, wherein the surjective mapping maps pixel intensity value of the first bit depth to pixel intensity value of the second bit depth.

3. The method of claim 2, wherein:
the second bit depth comprises a first pixel intensity and a second pixel intensity, wherein the first pixel intensity is less than the second pixel intensity; and
quantizing the input image comprises mapping a fewer number of pixel intensities of the first bit depth to the first pixel intensity than to the second pixel intensity.

4. The method of claim 1, further comprising:
obtaining, from the image processing pipeline, an output image comprising pixel intensity values of the second bit depth; and
de-quantizing the output image at least in part by applying a second nonlinear transform to pixel intensity values of the output image to generate a de-quantized output image comprising pixel intensity values of the first bit depth.

5. The method of claim 4, wherein the second nonlinear transform comprises an inverse of the first nonlinear transform.

6. The method of claim 1, wherein providing the quantized input image to the image processing pipeline comprises providing the quantized input image to a neural processor.

7. The method of claim 1, wherein providing the quantized input image to the image processing pipeline comprises providing the quantized input image to a digital signal processor (DSP).

8. The method of claim 1, wherein the image processing pipeline comprises one or more processors that are of lower power than the at least one processor.

9. The method of claim 1, wherein the first bit depth is 10 bits, 12 bits, 14 bits, or 16 bits.

10. The method of claim 1, wherein the second bit depth is 8 bits.

11. The method of claim 1, wherein:
the first bit depth is 10 bits, 12 bits, 14 bits, or 16 bits; and
the second bit depth is 8 bits.

12. The method of claim 1, wherein:
the image processing pipeline comprises a machine learning model trained using a plurality of quantized images comprising pixel intensity values of the second bit depth; and
providing the quantized input image to the image processing pipeline comprises providing the quantized input image to the machine learning model to obtain an enhanced output image.

13. An image processing system, the system comprising:
a non-volatile memory containing instructions for an image processing application; and
at least one processor directed by execution of the image processing application to:
obtain an input image comprising pixels having pixel intensity values of a first bit depth;
quantize the input image at least in part by applying a first nonlinear transform to pixel intensity values of the input image to generate a quantized input image comprising pixel intensity values of a second bit depth, wherein the second bit depth is less than the first bit depth; and
provide the quantized input image for image processing.

14. The method of claim 1, further comprising a non-transitory computer-readable storage medium storing instructions that, when executed by at least one processor, cause the at least one processor to:
obtain an input image comprising pixels having pixel intensity values of a first bit depth;
quantize the input image at least in part by applying a first nonlinear transform to pixel intensity values of the input image to generate a quantized input image comprising pixel intensity values of a second bit depth, wherein the second bit depth is less than the first bit depth; and
provide the quantized input image for image processing.

15. A computer-implemented method of training a machine learning model for image enhancement, the method comprising:
using at least one processor to perform:
obtaining a plurality of images comprising pixel intensity values of a first bit depth;
quantizing the plurality of images at least in part by applying a nonlinear transform to pixel intensity values of the plurality of images to generate a plurality of quantized images comprising pixel intensity values of a second bit depth, wherein the second bit depth is less than the first bit depth; and
training the machine learning model using the plurality of quantized images.

16. The method of claim 15, wherein the plurality of images comprises input images and target output images and training the machine learning model using the plurality of quantized images comprises applying a supervised learning algorithm to quantized input images and quantized target output images.

17. The method of claim 15, wherein the machine learning model comprises a neural network.

18. The method of claim 15, wherein training the machine learning model using the plurality of quantized images comprises training the machine learning model to denoise an input image.

19. A computer-implemented method of enhancing an image, the method comprising:
using at least one processor to perform:
obtaining an input image to be enhanced;
applying a nonlinear transform to pixel intensity values of the input image to obtain a transformed input image;
generating, using the transformed input image, an input be provided to a trained machine learning model; and
providing the generated input to the trained machine learning model to obtain an enhanced output image.

20. The method of claim 19, wherein:
the input image has a first variance of a noise property across the pixel intensity values of the input image;
the transformed input image has a second variance of the noise property across the pixel intensity values of the input image; and
the second variance is less than the first variance.

21. The method of 20, wherein the noise property is noise standard deviation.

22. The method of claim 19, wherein the trained machine learning model is trained to denoise the input.

23. The method of claim 19, wherein the trained machine learning model comprises a neural network.

24. The method of claim 19, wherein the trained machine learning model is generated by applying a supervised training algorithm to training data.

25. The method of claim 19, wherein:
the input image comprises pixel intensity values of a first bit depth;
generating the input using the transformed input image comprises:
quantizing the transformed input image to obtain a quantized input image comprising pixel intensity values of a second bit depth, wherein the second bit depth is less than the first bit depth; and
providing the generated input to the trained machine learning model comprises providing the quantized input image as the input to the trained machine learning model.

26. The method of claim 25, wherein quantizing the transformed input image comprises applying a surjective mapping to pixel intensity values of the transformed input image, wherein the surjective mapping maps the pixel intensity values of the first bit depth to pixel intensity values of the second bit depth.

27. The method of claim 26, wherein:
the second bit depth comprises a first pixel intensity and a second pixel intensity, wherein the first pixel intensity is less than the second pixel intensity; and
quantizing the input image comprises mapping a fewer number of pixel intensities of the first bit depth to the first pixel intensity than to the second pixel intensity.

28. An image processing system, the system comprising:
a non-volatile memory containing instructions for an image processing application; and
at least one processor directed by execution of the image processing application to:
obtain an input image to be enhanced;
apply a nonlinear transform to pixel intensity values of the input image to obtain a transformed input image;
generate, using the transformed input image, an input be provided to a trained machine learning model; and
provide the generated input to the trained machine learning model to obtain an enhanced output image.

29. The method of claim 19, the method further comprising a non-transitory computer-readable storage medium storing instructions that, when executed by at least one processor, cause the at least one processor to:
obtain an input image to be enhanced;
apply a nonlinear transform to pixel intensity values of the input image to obtain a transformed input image;
generate, using the transformed input image, an input be provided to a trained machine learning model; and
provide the generated input to the trained machine learning model to obtain an enhanced output image.
